(19) United States
(12) Patent Application Publication
(10) Pub. No.: US 2017/0253104 A1
(43) Pub. Date: Sep. 7, 2017

(54) VEHICLE HEAT MANAGEMENT SYSTEM

(71) Applicant: TOYOTA JIDOSHA KABUSHIKI KAISHA, Toyota-shi, Aichi-ken (JP)

(72) Inventors: Takashi AMANO, Susono-shi, Shizuoka-ken (JP); Hidefumi AIKAWA, Suntou-gun, Shizuoka-ken (JP); Kojiro HAYAKAWA, Suntou-gun, Shizuoka-ken (JP)

(73) Assignee: TOYOTA JIDOSHA KABUSHIKI KAISHA, Toyota-shi, Aichi-ken (JP)

(21) Appl. No.: 15/504,785

(22) PCT Filed: Aug. 7, 2015
(86) PCT No.: PCT/JP2015/072544

§ 371 Date: Feb. 17, 2017

(30) Foreign Application Priority Data
Sep. 4, 2014 (JP) 2014-180170

(51) Int. Cl. B60H 1/00

(52) U.S. Cl. CPC B60H 1/00885; B60H 1/00899; B60H 1/00328; B60H 1/00428; B60H 1/00421; B60H 1/00321; B60H 1/00642; B60H 1/00814; B60H 1/00878; B60H 2001/00114; B60H 2001/00928; B60L 2240/10; B60L 2250/26; B60L 2240/36; B60L 2240/445

(57) ABSTRACT

A heat management system for vehicles comprises: a first circulation circuit which cools an engine body of an internal combustion engine and includes a first pump for pressure-feeding a refrigerant; a second circulation circuit including an exhaust heat recovery apparatus for recovering exhaust heat from the internal combustion engine, a heater core used for air-conditioning of a vehicle, and a second pump for pressure-feeding the refrigerant; communication passages allowing the first circulation circuit to communicate with the second circulation circuit; and an on-off valve provided in the first communication passage, and switching between the communication between the first circulation circuit and the second circulation circuit and the preventing of communication therebetween, wherein the on-off valve is controlled such that the refrigerant temperature of the first circulation circuit is higher than that of the second circulation circuit.

### TECHNICAL FIELD

The present invention relates to a vehicle heat management system that is applied to a vehicle to which an internal combustion engine is mounted.

### BACKGROUND ART

A vehicle heat management system is per se known (refer to Patent Document #1) having a plurality of circulation circuits that circulate coolant, and in which, according to the operational state (i.e. according to the temperatures at various locations), changeover is performed by a changeover valve between mutual communication of a circulation circuit that cools the body of the internal combustion engine and a circulation circuit to which are provided a thermal storage vessel and a heater core, and prevention of that mutual communication. Moreover, apart from the above, Patent Documents #2-#4 in the Citation List are considered to have some relevance to the present invention.

### CITATION LIST

### Patent Literature

Patent Document #1: JP2004-285958A.

Patent Document #2: JP2004-76603A.

Patent Document #3: JP2005-509777A.

Patent Document #4: JP1997-158724A.

### SUMMARY OF INVENTION

### Technical Problem

With the vehicle heat management system of Patent Document #1, consideration does not extend to adjustment of the coolant temperature in response to change of the demand for cooling the internal combustion engine, such as, for example, being able to cope with knocking of the internal combustion engine or with local boiling of the coolant, and accordingly there is room for improvement in the control method.

Accordingly, the object of the present invention is to provide a vehicle heat management system that is capable of adjusting the coolant temperature in response to the demand for cooling the internal combustion engine.

### Solution to Technical Problem

The vehicle heat management system of the present invention is applied to a vehicle to which an internal combustion engine is mounted, and comprises: a first circulation circuit that cools an engine body of the internal combustion engine, and in which is provided a first pump that pressure feeds coolant; a second circulation circuit in which are provided an exhaust heat recovery apparatus that recovers exhaust heat of the internal combustion engine, a heater core that is used for air conditioning of the vehicle, and a second pump that pressure feeds coolant; a communicating section that communicates together the first circulation circuit and the second circulation circuit; a control valve provided in the communicating section, that can be changed over between communicating together the first circulation circuit and the second circulation circuit, and preventing such communication; and a coolant temperature control device configured to control the control valve, so as to implement a state in which the temperature of the coolant flowing in the first circulation circuit is higher than the temperature of the coolant flowing in the second circulation circuit.

According to this vehicle heat management system, control is performed so as to establish a state in which the temperature of the coolant in the first circulation circuit for cooling the body of the internal combustion engine is higher than the temperature of the coolant in the second circulation circuit in which the exhaust heat recovery apparatus and the heater core are provided. Due to this, a temperature difference is obtained in which the temperature of the coolant in the first circulation circuit is higher than the temperature of the coolant in the second circulation circuit. And due to this, by controlling the control valve so as to communicate together the first circulation circuit and the second circulation circuit when the demand for cooling of the internal combustion engine changes in the direction to increase, it is possible to reduce the temperature of the coolant in the first circulation circuit by mixing together the coolant at high temperature in the first circulation circuit and the coolant at low temperature in the second circulation circuit.

As one aspect of the vehicle heat management system of the present invention, it would be acceptable further to provide an EGR cooler in the second circulation circuit. According to this aspect, on the one hand, before warming up of the EGR cooler has been completed, it is possible to promote warming up of the EGR cooler by flowing the coolant that is at high temperature in the first circulation circuit into the second circulation circuit, and on the other hand, after the warming up of the EGR cooler has been completed, the cooling performance of the EGR cooler is ensured due to the coolant at low temperature in the second circulation circuit. Because of this, it becomes possible to perform temperature control that is well adapted to the characteristics of the EGR cooler.

And, as another aspect of the vehicle heat management system of the present invention, it would also be acceptable to arrange for the coolant temperature control means to control the control valve so as, if the load demanded from the internal combustion engine arrives at a load region in which knocking may easily occur, or if there is a possibility that the load may arrive at that load region, to communicate together the first circulation circuit and the second circulation circuit. According to this aspect, in a situation in which knocking can easily occur, it is possible to reduce the temperature of the coolant in the first circulation circuit by communicating together the first circulation circuit and the second circulation circuit. Due to this, it is possible to suppress the occurrence of knocking of the internal combustion engine.

Moreover, as yet another aspect of the vehicle heat management system of the present invention, it would also be acceptable, during dead soak, to arrange for the coolant temperature control means to control the control valve so as to communicate together the first circulation circuit and the second circulation circuit. According to this mode, it is possible to reduce the temperature of the coolant in the first circulation circuit during dead soak by communicating together the first circulation circuit and the second circulation circuit. Due to this, it is possible to suppress the occurrence of local boiling during dead soak.

### BRIEF DESCRIPTION OF DRAWINGS

FIG. 1 is a figure showing the overall structure of a vehicle heat management system according to a first embodiment;

FIG. 2 is an explanatory figure showing temperature rise characteristics of circulation circuits;

FIG. 3 is an explanatory figure showing characteristics of pumps;

FIG. 4 is a flow chart showing an example of a control routine that performs control for prevention of knocking;

FIG. 5 is a flow chart showing an example of a control routine that performs control during dead soak;

FIG. 6 is a flow chart showing an example of a control routine that performs control when a heater is required;

FIG. 7 is a flow chart showing an example of a control routine that performs control for promoting warming up;

FIG. 8 is a flow chart showing an example of a control routine that performs control for promoting warming up during starting;

FIG. 9 is a flow chart showing an example of a control routine that performs control when warming up has been completed;

FIG. 10 is a figure showing the overall structure of a vehicle heat management system according to a second embodiment;

FIG. 11 is a flow chart showing an example of a control routine according to this second embodiment;

FIG. 12 is a figure showing the overall structure of a vehicle heat management system according to a third embodiment;

FIG. 13 is a flow chart showing an example of a control routine according to this third embodiment; and

FIG. 14 is a figure showing the overall structure of a vehicle heat management system according to a fourth embodiment.

### DESCRIPTION OF EMBODIMENTS

### Embodiment #1

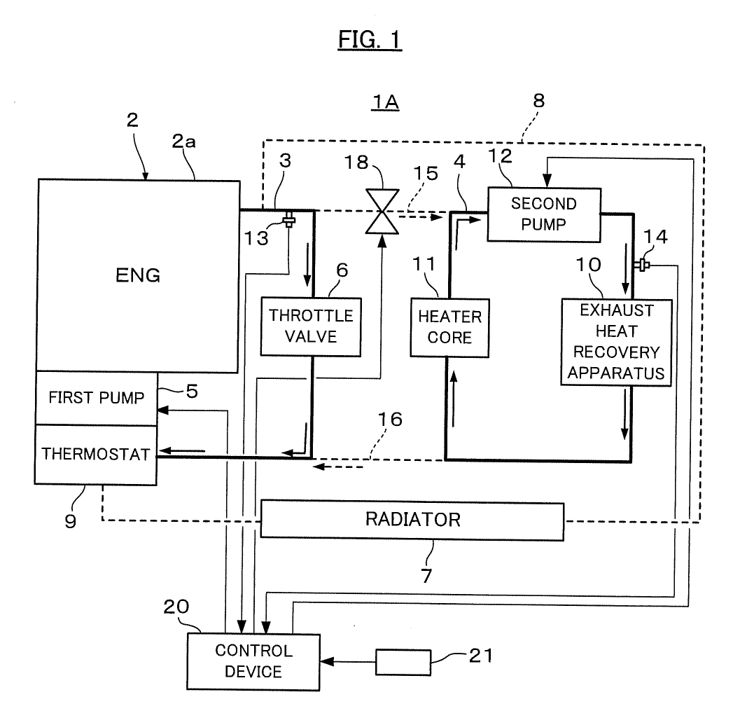

As shown in FIG. 1, a vehicle heat management system (hereinafter termed a heat management system) 1A is applied to a vehicle (not shown in the figures) to which an internal combustion engine 2 is mounted. This heat management system 1A comprises two circulation circuits 3, 4 that circulate coolant. A first pump 5 is provided that pressure feeds coolant to the first circulation circuit 3, and coolant that is thus pressure fed by the first pump 5 cools an engine body 2a that includes a cylinder block and a cylinder head by circulating around the first circulation circuit 3. Furthermore, the first circulation circuit 3 passes through a throttle valve 6, and this throttle valve 6 is also cooled by the first circulation circuit 3. The first pump 5 has a capacity that is capable of satisfying the maximum cooling requirement of the internal combustion engine 2, and is built as an electrically operated type pump of a per se known prior art type. A branching circuit 8 in which a radiator 7 is provided branches off from the first circulation circuit 3, with the branching off position of this branching circuit 8 being set to be downstream of the engine body 2a. The branching circuit 8 connects back to the first circulation circuit 3 via a thermostat 9. Accordingly, when the temperature of the coolant in the first circulation circuit 3 reaches the opening temperature of the thermostat 9, the coolant in the first circulation circuit 3 flows through the branching circuit 8 and is cooled by the radiator 7, due to the branching circuit 8 being opened by the thermostat 9.

An exhaust heat recovery apparatus 10 that recovers heat from the exhaust of the internal combustion engine 2, a heater core 11 that is employed for air conditioning of the vehicle, and a second pump 12 that pressure feeds the coolant are provided in the second circulation circuit 4. The second pump 12 is an electrically operated type pump and has a smaller capacity than that of the first pump 5. This second pump 12 is capable of flowing coolant through the heater core 11, and moreover has a capacity that is capable of satisfying the lower limit level cooling requirement of the internal combustion engine 2.

A first temperature sensor 13 is provided in the first circulation circuit 3, and a second temperature sensor 14 is provided in the second circulation circuit 4. The temperature of the coolant flowing in the first circulation circuit 3 is detected by the first temperature sensor 13, and the temperature of the coolant flowing in the second circulation circuit 4 is detected by the second temperature sensor 14.

Two communication passages 15, 16 communicate together the first circulation circuit 3 and the second circulation circuit 4, and serve as a communicating section. An on/off valve 18 is provided in the first communication passage 15, and operates between a closed position in which it closes the first communication passage 15 and an open position in which it opens the first communication passage 15. When the on/off valve 18 is open, the first communication passage 15 is opened, and, while circulation of coolant is maintained in the circulation circuits 3, 4 as shown by the broken arrow signs, a portion of the coolant flowing in the first circulation circuit 3 flows to the second circulation circuit 4 via the first communication passage 15, and moreover the same amount of coolant flows back from the second circulation circuit 4 via the second communication passage 16 to the first circulation circuit 3. Communication between the first circulation circuit 3 and the second circulation circuit 4 is implemented in this manner.

On the other hand, when the on/off valve 18 is closed and the first communication passage 15 is closed, simultaneously with the stopping of flow of coolant in the first communication passage 15, the flow of coolant in the second communication passage 16 also stops, and communication between the first circulation circuit 3 and the second circulation circuit 4 is prevented. Since communication together of the first circulation circuit 3 and the second circulation circuit 4 and prevention of such communication are changed over in this manner by operation of the on/off valve 18 that is provided in one of the two communication passages 15, 16, accordingly the on/off valve 18 corresponds to the “control valve” of the Claims.

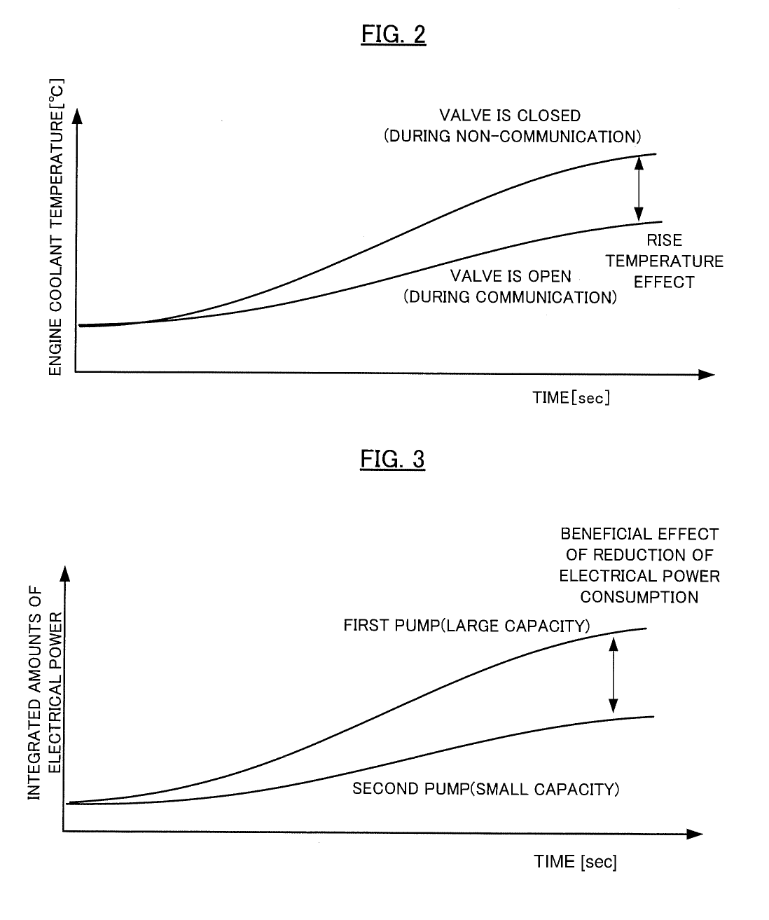

In this heat management system 1A, by changing over between communication together of the first circulation circuit 3 and the second circulation circuit 4 and prevention of such communication, it is possible to change over the temperature rise characteristic of the coolant between a characteristic during communication and a characteristic during non-communication. Since, as shown in FIG. 2, when the on/off valve 18 is open (i.e. during communication), due to communication between the first circulation circuit 3 and the second circulation circuit 4, the thermal capacity becomes greater than when the valve is closed (i.e. during non-communication), accordingly the rate of rise of the temperature of the coolant during communication also becomes slower than during non-communication. Therefore, when rapid rise of the coolant temperature is necessary such as before the internal combustion engine has been warmed up or the like, it is possible to implement rising of the temperature of the coolant over a short time period by closing the on/off valve 18 and preventing communication between the first circulation circuit 3 and the second circulation circuit 4. Furthermore, since the heat management system 1A uses the two pumps 5, 12 whose capacity is different, therefore, according to requirements, it is possible to obtain the beneficial effect shown in FIG. 3 of reduction of electrical power consumption by only using the second pump 12 whose capacity is smaller. FIG. 3 is a figure for comparison of the integrated amounts of electrical power used by the pumps 5 and 12, and from this figure it will be understood that the power consumption is lower when the second pump 12 is used than when the first pump 5 is used.

A control device 20 is provided to this heat management system 1A for performing control of the on/off valve 18 and control of the pumps 5, 12. This control device 20 is built around a computer. The control device 20 could also serve as an engine control unit for performing control of the internal combustion engine 2. The output signals from the first temperature sensor 13 and the second temperature sensor 14 are inputted to the control device 20. Due to this, the control device 20 is able to acquire the temperatures of the coolant in the first circulation circuit 3 and in the second circulation circuit 4. Moreover, the signal from an accelerator opening amount sensor 21, which outputs a signal corresponding to the amount by which an accelerator pedal not shown in the figures is depressed, is also inputted to the control device 20.

The control device 20 functions as the “coolant temperature control device” of the Claims, and principally serves to control the on/off valve 18 in consideration of the temperature rise characteristics of the circulation circuits 3, 4 described above, so that the temperature of the coolant in the first circulation circuit 3 becomes higher than the temperature of the coolant in the second circulation circuit 4. Due to this, a temperature difference is obtained in which the temperature of the coolant in the first circulation circuit 3 is higher than the temperature of the coolant in the second circulation circuit 4. And, by controlling the on/off valve 18 according to this state, the temperatures of the coolant in the circulation circuits 3, 4 may be adjusted by utilizing the above described temperature difference. In the following, various types of control implemented by the control device 20 will be explained.

### Knocking Prevention Control

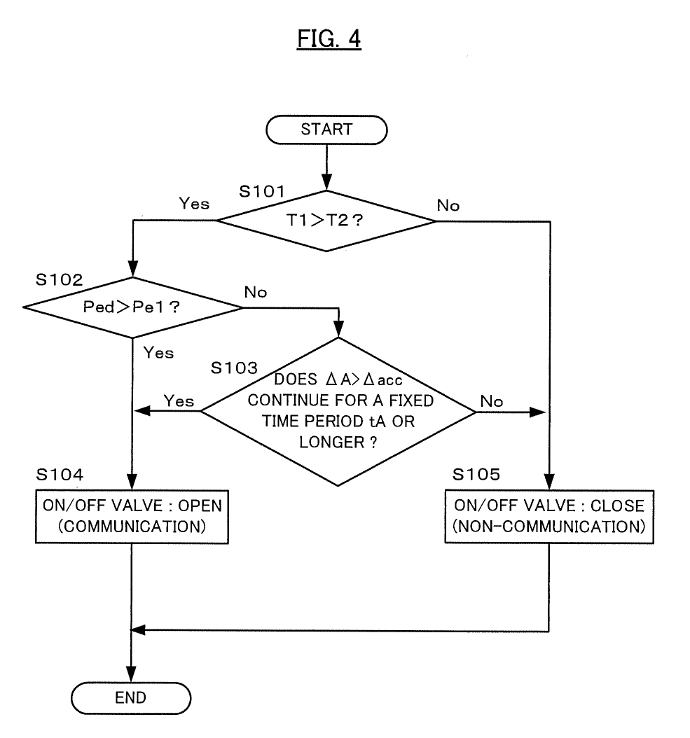

Knocking prevention control is performed in a state in which, after warming up of the internal combustion engine 2 has been completed, cooling by the radiator 7 is being implemented while the thermostat 9 is open and the first pump is being driven. In the prior art, the cooling requirement during high load when knocking can easily occur relies upon the heat dissipation performance by the radiator, but in this embodiment, during knocking prevention control, knocking is suppressed by utilizing the temperature difference between the temperature of the coolant in the first circulation circuit 3 and the temperature of the coolant in the second circulation circuit 4. FIG. 4 is a flow chart showing an example of a control routine for knocking prevention control. A program for the control routine of FIG. 4 is stored in the control device 20, and is readout in a timely manner and executed repeatedly at predetermined intervals.

First in a step S101 the control device 20 acquires the coolant temperature T1 in the first circulation circuit 3 on the basis of the signal from the first temperature sensor 13, acquires the coolant temperature T2 in the second circulation circuit 4 on the basis of the signal from the second temperature sensor 14, and makes a decision as to whether or not the coolant temperature T1 is higher than the coolant temperature T2. If the coolant temperature T1 is higher than the coolant temperature T2, then the flow of control proceeds to a step S102, while, if this is not the case, then the flow of control is transferred to a step S105.

In the step S102, the control device 20 makes a decision as to whether or not the load Ped required from the internal combustion engine 2 is greater than a threshold value Pe1 that determines the load region in which knocking can easily occur. If the required load Ped is greater than the threshold value Pe1, then the flow of control is transferred to a step S104, in which the control device 20 opens the on/off valve 18. Due to this, it is possible to suppress the occurrence of knocking, since the coolant at low temperature in the second circulation circuit 4 flows into the first circulation circuit 4 and the temperature of the coolant in the first circulation circuit 3 drops.

On the other hand, if the required load Ped is less than or equal to the threshold value Pe1, then the flow of control proceeds to a step S103. In this step S103, the control device 20 acquires the accelerator amount of change ΔA by referring to the signal from the accelerator opening amount sensor 21, and makes a decision as to whether or not this accelerator amount of change ΔA is greater than a threshold value Δacc. This decision process is performed in order to forecast whether or not, even though the load demanded from the internal combustion engine 2 has not reached the load region in which knocking can easily occur at the present time point, it may reach this load region in the near future.

Since, if the condition that the accelerator amount of change ΔA is greater than the threshold value Δacc continues for a fixed time period tA or longer, then there is a possibility that in the near future the load region in which knocking can easily occur may be reached, accordingly the flow of control proceeds to the step S104 in which the control device 20 opens the on/off valve 18 so as to cause the temperature of the coolant in the first circulation circuit 3 to drop. On the other hand, since the possibility that knocking may occur is low if the condition that the accelerator amount of change ΔA is less than or equal to the threshold value Δacc continues for the fixed time period tA or longer, accordingly the flow of control proceeds to a step S105 in which the control device 20 closes the on/off valve 18 so that the state in which the temperature of the coolant in the first circulation circuit 3 is higher than the temperature of the coolant in the second circulation circuit 4 is maintained.

According to the knocking prevention control shown in FIG. 4, in a case in which knocking may easily occur, it is possible to suppress the occurrence of knocking by causing the coolant at low temperature in the second circulation circuit 4 to flow into the first circulation circuit 3, so that the temperature of the coolant in the first circulation circuit 3 is reduced.

### Control During Dead Soak

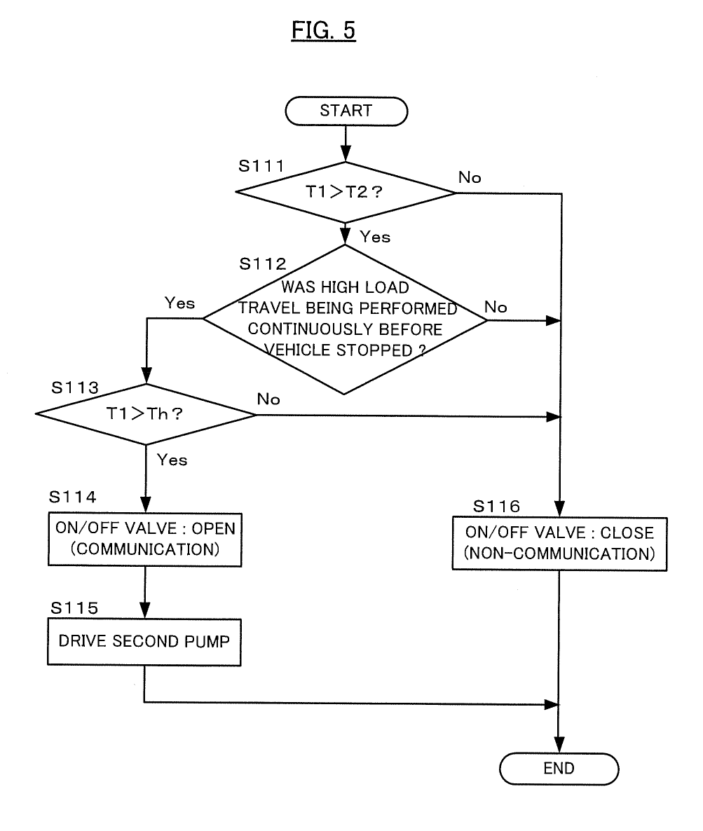

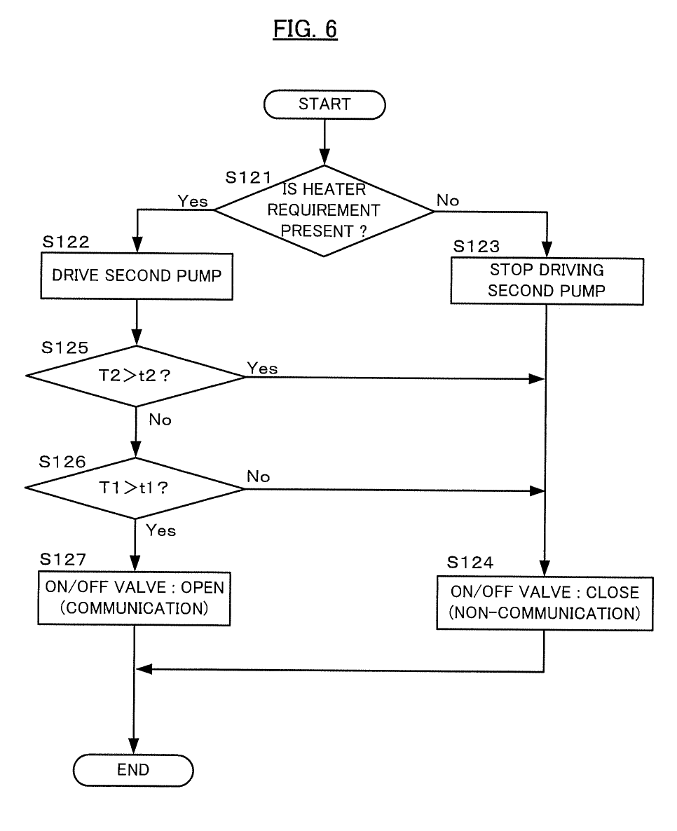

Control during dead soak is a type of control that prevents local boiling in the interior of the internal combustion engine 2 when the vehicle is stopped and the operation of the internal combustion engine 2 is stopped in a state in which the amount of heat in the internal combustion engine 2 is large. While, in the prior art, local boiling was prevented by continuously performing cooling while the vehicle was stopped by maximizing the output of the pump or by maximizing the output of a radiator fan during dead soak, there was a problem that the consumption of electrical power after stopping the vehicle was high, and also there was a problem of noise. However, in this embodiment, in the control during dead soak, the occurrence of local boiling during dead soak is suppressed by utilizing the temperature difference between the temperature of the coolant in the first circulation circuit 3 and the temperature of the coolant in the second circulation circuit 4. FIG. 5 is a flow chart showing an example of a control routine that performs control during dead soak. A program for the control routine of FIG. 5 is stored in the control device 20, and is read out in a timely manner and executed repeatedly at predetermined intervals.

First in a step S111 the control device refers to the signals from the temperature sensors 13, 14 and makes a decision as to whether or not the coolant temperature T1 is higher than the coolant temperature T2. If the coolant temperature T1 is higher than the coolant temperature T2, then the flow of control proceeds to a step S112, while if this is not the case then the flow of control is transferred to a step S116.

In the step S112, the control device 20 makes a decision as to whether or not, before the vehicle stopped, high load travel was being performed continuously. By making this decision, it is possible to estimate the magnitude of the integrated amount of heat accumulated in the internal combustion engine 2. If high load travel was not being performed continuously before the vehicle stopped, then the possibility of occurrence of local boiling during dead soak is low, and accordingly the flow of control is transferred to the step S116, in which the control device 20 closes the on/off valve 18 and maintains the state in which the coolant temperature in the first circulation circuit 3 is higher than the coolant temperature in the second circulation circuit 4. On the other hand, if high load travel was being performed continuously before the vehicle stopped, then the flow of control proceeds to a step S113.

In the step S113, the control device 20 makes a decision as to whether or not the coolant temperature T1 is higher than a threshold value Th. This threshold value Th is set to around 95° C. to 100° C. If the coolant temperature T1 is lower than the threshold value Th, then the possibility that local boiling will occur during dead soak is low and the flow of control is transferred to the step S116, in which the control device 20 closes the on/off valve 18 and maintains the state in which the coolant temperature in the first circulation circuit 3 is higher than the coolant temperature in the second circulation circuit 4. On the other hand, if the coolant temperature T1 is higher than the threshold value Th, then the flow of control proceeds to the step S114, in which the control device 20 opens the on/off valve 18 and thereby reduces the coolant temperature in the first circulation circuit 3. And in the next step S115 the control device 20 only drives the second pump 12. In other words, the control device stops driving the first pump 5 and drives the second pump 12. In this case, instead of only driving the second pump 12, it would also be acceptable to arrange only to drive the first pump 5. In other words, circulation of the coolant may be ensured by driving either one of the pumps.

According to the control of this embodiment during dead soak, when the possibility that local boiling of the internal combustion engine 2 may occur during dead soak is high, then it is possible to suppress the occurrence of local boiling by causing the coolant at low temperature in the second circulation circuit 4 to flow into the first circulation circuit 3 so that the temperature of the coolant in the first circulation circuit 3 is reduced. Moreover, since the demand for cooling during dead soak is satisfied by driving only one of the two pumps 5, 12 without employing the radiator fan, accordingly it is possible to reduce the consumption of electrical power, and also to reduce the noise.

### Control While the Heater is Required

Control while the heater is required is implemented when room heating becomes necessary during management of the quality of the air within the vehicle passenger compartment, i.e. when the heater is required so that it has become necessary to transfer heat from the coolant to the heater core 11. While fundamentally such a heating requirement is fulfilled by utilizing exhaust heat recovered by the exhaust heat recovery apparatus 10, if this is insufficient for the requirements of the heater, then the requirement is satisfied by controlling the on/off valve 18 so that the coolant at high temperature in the first circulation circuit 3 is flowed into the second circulation circuit 4. FIG. 6 is a flow chart showing an example of a control routine that performs control when the heater is required. A program for the control routine of FIG. 6 is stored in the control device 20, and is read out in a timely manner and executed repeatedly at predetermined intervals.

In a step S121, the control device 20 determines whether or not the above described heater requirement currently is present. This presence or absence of a heater requirement may, for example, be determined on the basis of the state of actuation of a passenger compartment heating switch not shown in the figures that is mounted to an air conditioner of the vehicle. If a heater requirement is currently present, then the flow of control proceeds to a step S122, while if no heater requirement is present, then the flow of control is transferred to a step S123. In the step S122, the control device 20 drives the second pump 12. And in the step S123 the control device 20 stops driving the second pump 12, and subsequently in a step S124 the on/off valve 18 is closed so that the state in which the coolant temperature in the first circulation circuit 3 is higher than the coolant temperature in the second circulation circuit 4 is maintained.

In a step S125, the control device 20 acquires the coolant temperature T2 by referring to the signal from the second temperature sensor 14, and makes a decision as to whether or not this coolant temperature T2 is higher than a threshold value t2 that is set as the temperature at which the passenger compartment heating can perform. If the coolant temperature T2 is higher than the threshold value t2, then the flow of control is transferred to the step S124 in which the on/off valve 18 is closed, since it is possible to satisfy the heater requirement by using exhaust heat recovered by the exhaust heat recovery apparatus 10 as a heat source. On the other hand, if the coolant temperature T2 is less than or equal to the threshold value t2, then the flow of control proceeds to a step S126, in which the control device 20 acquires the coolant temperature T1 by referring to the signal from the first temperature sensor 13, and makes a decision as to whether or not this coolant temperature T1 is higher than a threshold value t1.

The threshold value t1 is set to a higher value than the threshold value t2; the threshold value t1 is set as a reference as to whether or not it is possible to satisfy the requirement of the heater by flowing coolant from the first circulation circuit 3 into the second circulation circuit 4. Thus, if the coolant temperature T1 is less than or equal to the threshold value t1, then the flow of control is transferred to the step S124 and the on/off valve 18 is closed, since it is not possible to satisfy the requirement of the heater by flowing in coolant from the first circulation circuit 3. On the other hand, if the coolant temperature T1 is greater than the threshold value t1, then the flow of control is transferred to a step S127, in which the control device 20 opens the on/off valve 18 and the coolant at high temperature in the first circulation circuit 3 is flowed into the second circulation circuit 4, so that the temperature of the coolant in the second circulation circuit 4 is raised and the requirement of the heater is satisfied.

According to the control of this embodiment when the heater is required, it is possible to fulfill a shortage due to the requirement of the heater by controlling the on/off valve 18 and causing coolant in the first circulation circuit 3 to flow into the second circulation circuit 4. Furthermore, when the heater is required, it is possible to contribute to economy of electrical power, since the coolant is circulated by driving the second pump 12 which is more compact and economical.

### Warming Up Promotion Control

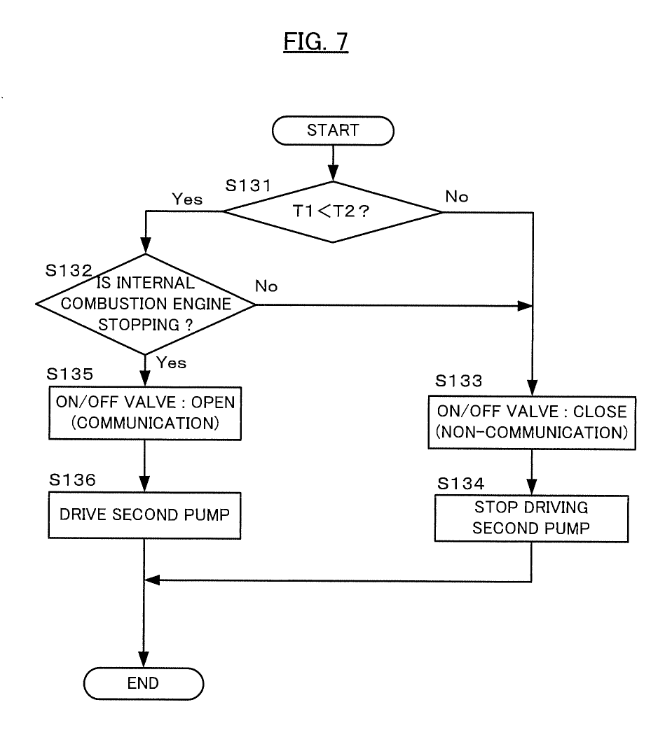

If the vehicle is a car equipped with idling stop or a hybrid car, then, because of implementation of idling stop or EV traveling, due to the influence of the air current caused by vehicle movement or the influence of dissipation of heat to the external air, in some cases, the state in which the temperature of the coolant in the first circulation circuit 3 is reduced before warming up of the internal combustion engine 2 has been completed (i.e. the half warmed up state) may continue for a comparatively long time. In this type of state, it may be supposed that the temperature of the coolant in the first circulation circuit 3 has become lower than the temperature of the coolant in the second circulation circuit 4. Warming up promotion control is a form of control in which, when due to the influence of the traveling environment or the running state of the vehicle, the temperature of the coolant in the first circulation circuit 3 has become lower than the temperature of the coolant in the second circulation circuit 4, then warming up is promoted by the coolant at higher temperature in the second circulation circuit 4 flowing into the first circulation circuit 3. FIG. 7 is a flow chart showing an example of a control routine that performs warming up promotion control. A program for the control routine of FIG. 7 is stored in the control device 20, and is read out in a timely manner and executed repeatedly at predetermined intervals.

In a step S131, the control device 20 refers to the signals of the temperature sensors 13, 14, and makes a decision as to whether or not the temperature T1 of the coolant in the first circulation circuit 3 is lower than the temperature T2 of the coolant in the second circulation circuit 4. If the coolant temperature T1 is lower than the coolant temperature T2 then the flow of control proceeds to a step S132. But if the coolant temperature T1 is greater than or equal to the coolant temperature T2 then the flow of control is transferred to a step S133, and the control device 20 closes the on/off valve 18 and stops the driving of the second pump 12 in the next step S134, so that the temperature of the coolant in the first circulation circuit 3 comes to be in a state of being higher than the temperature of the coolant in the second circulation circuit 4.

In the step S132, the control device 20 makes a decision as to whether or not the internal combustion engine 2 is stopping due to a cause such as idling stop or EV travel or the like. If the internal combustion engine 2 is not stopping, then the processing of the step S133 and the step S134 is implemented in order to promote warming up, so as not to allow the heat of the internal combustion engine 2 to escape. On the other hand, if the internal combustion engine is stopping, then the flow of control is transferred to a step S135, and the control device 20 opens the on/off valve 18 and causes the coolant at high temperature in the second circulation circuit 4 to flow into the first circulation circuit 3, so that the temperature of the coolant in the first circulation circuit 3 is raised and thereby warming up is promoted. And then in the step S136 the second pump 12 is driven.

According to the warming up promotion control of this embodiment, when the temperature of the coolant in the first circulation circuit 3 has become lower than the temperature of the coolant in the second circulation circuit 4, the coolant at high temperature in the second circulation circuit 4 is flowed into the first circulation circuit 3, so that it is possible to promote warming up, since the temperature of the coolant in the first circulation circuit 3 is elevated. Moreover, it is possible to contribute to economy of electrical power, since the coolant is circulated by driving the second pump 12 which is more compact and economical.

### Control for Promoting Warming Up During Starting

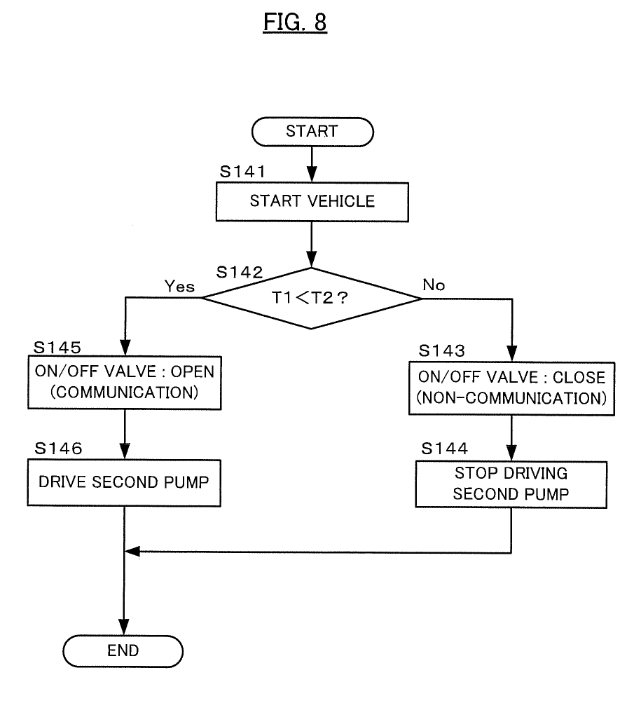

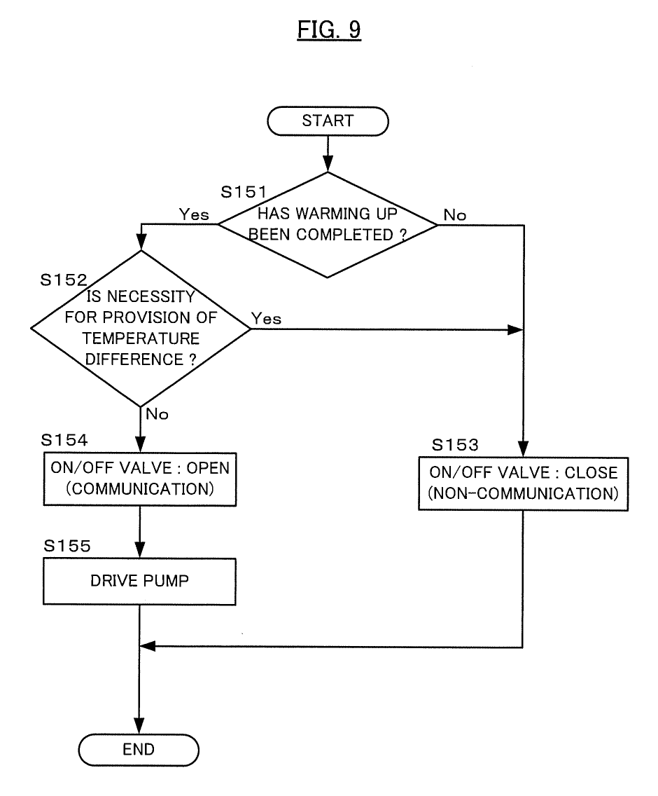

Warming up promotion control during starting is a type of control which promotes warming up of the internal combustion engine 2 by causing coolant at high temperature in the second circulation circuit 4 to flow into the first circulation circuit 3 during starting of the vehicle, in other words during the state in which, when operation of the vehicle is being commenced, the temperature of the coolant in the first circulation circuit 3 is lower than the temperature of the coolant in the second circulation circuit 4. FIG. 8 is a flow chart showing an example of a control routine that performs control for promoting this warming up during starting. A program for the control routine of FIG. 8 is stored in the control device 20, and is readout in a timely manner and executed repeatedly at predetermined intervals.

In a step S141, the control device 20 starts the vehicle according to a request for starting of the vehicle. Then in a step S142 the control device 20 refers to the signals of the temperature sensors 13, 14 and makes a decision as to whether or not the temperature T1 of the coolant in the first circulation circuit 3 is lower than the temperature T2 of the coolant in the second circulation circuit 4. If the coolant temperature T1 is lower than the coolant temperature T2, then the flow of control is transferred to a step S145. But if the coolant temperature T1 is greater than or equal to the coolant temperature T2, then the flow of control proceeds to a step S143, in which the control device 20 closes the on/off valve 18 and then stops driving the second pump 12 in the next step S144, so that a state is obtained in which the temperature of the coolant in the first circulation circuit 3 is higher than the temperature of the coolant in the second circulation circuit 4. And then in the step S145 the control device 20 opens the on/off valve 18 and causes the coolant at high temperature in the second circulation circuit 4 to flow into the first circulation circuit 3, so that the temperature of the coolant in the first circulation circuit 3 is raised and thereby warming up is promoted. And then in the step S146 the second pump 12 is driven.

According to the warming up promotion control during starting of this embodiment, when, during starting operation of the vehicle, the temperature of the coolant in the first circulation circuit 3 has become lower than the temperature of the coolant in the second circulation circuit 4, the coolant at high temperature in the second circulation circuit 4 is flowed into the first circulation circuit 3, so that it is possible to promote warming up, since the temperature of the coolant in the first circulation circuit 3 is elevated. Moreover, it is possible to contribute to economy of electrical power, since the coolant is circulated by driving the second pump 12 which is more compact and economical.

### Control When Warming Up is Completed

Control when warming up has been completed is a type of control in which, after warming up of the internal combustion engine 2 has been completed, the on/off valve 18 is controlled according to the necessity for provision of a temperature difference between the temperatures of the coolant in the circulation circuits 3, 4. Since dissipation of heat by the radiator 7 is useless if there is no requirement to provide such a temperature difference, accordingly the coolant at high temperature in the first circulation circuit 3 is flowed into the second circulation circuit 4 so that the temperature of the coolant in the second circulation circuit 4 is elevated. FIG. 9 is a flow chart showing an example of a control routine that performs control when warming up has been completed. A program for the control routine of FIG. 9 is stored in the control device 20, and is readout in a timely manner and executed repeatedly at predetermined intervals.

In a first step S151 the control device 20 makes a decision as to whether or not warming up of the internal combustion engine 2 has been completed. This decision as to completion of warming up is implemented by determining whether or not the temperature of the coolant in the first cooling circuit 3 has reached the opening temperature of the thermostat 9. If warming up has been completed then the flow of control proceeds to a step S152. But if warming up has not been completed then the flow of control is transferred to a step S153, in which the control device 20 closes the on/off valve 18 and thus maintains the state in which the temperature of the coolant in the first cooling circuit 3 is higher than the temperature of the coolant in the second circulation circuit 4.

In the step S152, the control device 20 determines upon the necessity for provision of a temperature difference between the temperatures of the coolant in the circulation circuits 3, 4. As cases in which it is necessary to provide such a temperature difference, there may be cited the case in which there is no heater requirement as described above, the case in which it is necessary to suppress knocking, the case in which it is necessary to suppress the generation of local boiling during dead soak, and so on. If it is necessary to provide such a temperature difference, then the flow of control proceeds to a step S153, and the state in which the temperature of the coolant in the first cooling circuit 3 is higher than the temperature of the coolant in the second circulation circuit 4 is maintained. On the other hand, if there is no necessity to provide any such temperature difference, then the flow of control is transferred to a step S154, in which the control device 20 opens the on/off valve 18 and causes the coolant at high temperature in the first circulation circuit 3 to flow into the second circulation circuit 4, so that the temperature of the coolant in the second circulation circuit 4 is raised. And then in the step S155 the control device 20 drives either one or both of the first pump 5 and the second pump 12, so that the coolant is circulated.

According to the control of this embodiment when warming up has been completed, if it is not necessary to provide a temperature difference between the temperature of the coolant in the first circulation circuit 3 and the temperature of the coolant in the second circulation circuit 4, then the on/off valve 18 is opened, and the coolant at high temperature in the first circulation circuit 3 flows into the second circulation circuit 4. As a result, the temperature of the coolant in the first circulation circuit 3 drops, and, due to the thermostat 9 closing, heat dissipation by the radiator 7 is avoided.

### Embodiment #2

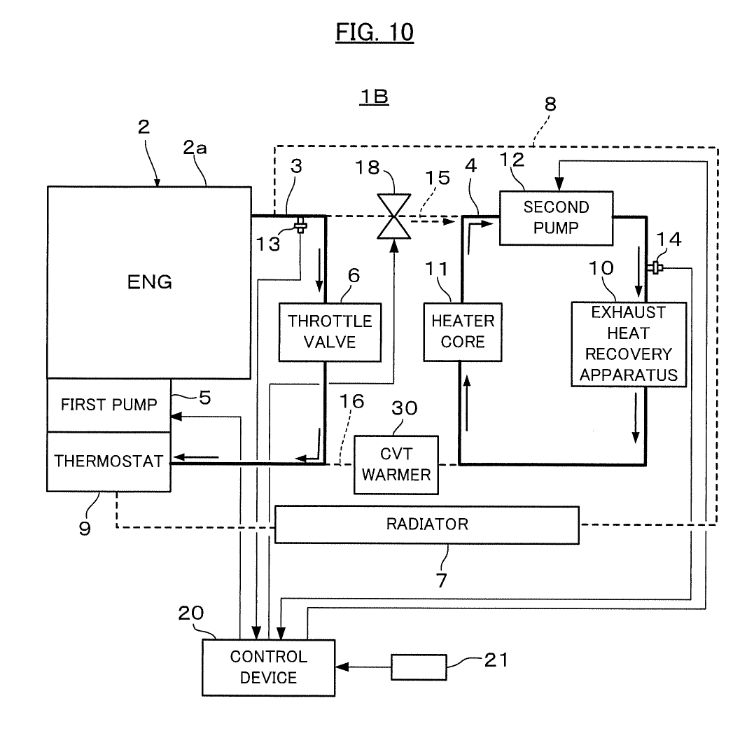

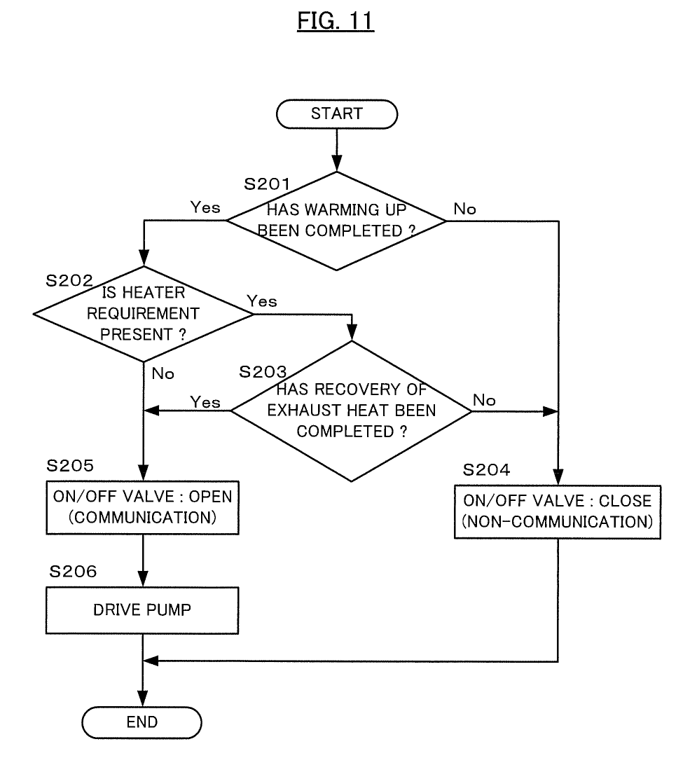

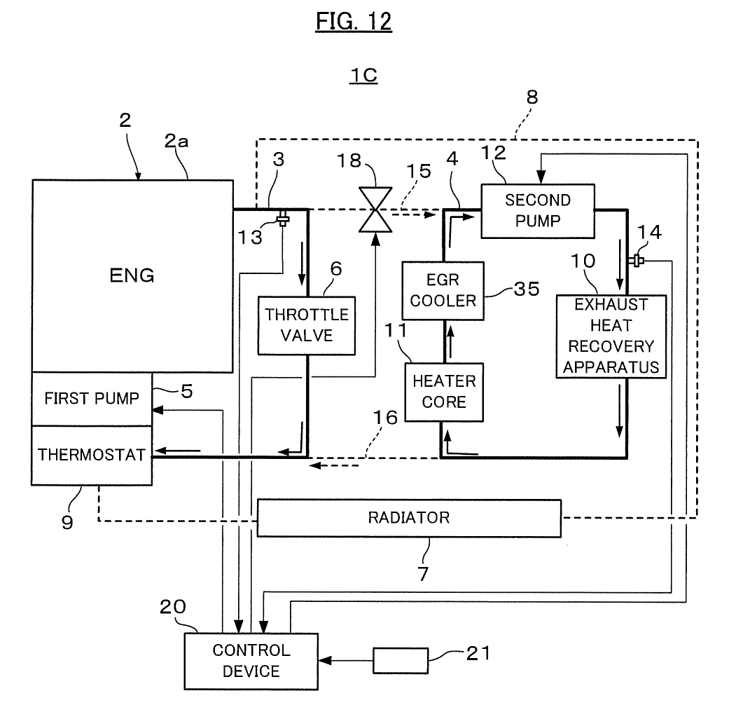

Next, a second embodiment of the present invention will be explained with reference to FIGS. 10 and 11. The same reference symbols will be appended in FIG. 10 to structures that are the same as corresponding structures of the first embodiment, and explanation thereof will be omitted. As shown in FIG. 10, the heat management system 1B of this second embodiment is characterized by the feature that a CVT warmer 30 is disposed in the second communication passage 16. This CVT warmer 30 is of a per se known type that is used for warming up a stepless speed change mechanism that is mounted to the vehicle but not shown in the figures, and is disposed in the bottom portion of a casing of the stepless speed change mechanism. Since, as described above, the flow of coolant in both the two communication passages 15, 16 is stopped when the on/off valve 18 is closed, accordingly no heat of the coolant is not transferred to the CVT warmer 30 while the on/off valve 18 is closed. Accordingly, as compared to the case when a CVT warmer 30 is provided in the first circulation circuit 3 or in the second circulation circuit 4 in both of which coolant is always circulating, it is difficult for the CVT warmer 30 to provide any hindrance to warming up of the internal combustion engine 2 or to heating of the passenger compartment.

FIG. 11 is a flow chart showing an example of a control routine according to this second embodiment. A program for the control routine of FIG. 11 is stored in the control device 20, and is read out in a timely manner and executed repeatedly at predetermined intervals. First in a step S201 the control device 20 makes a decision as to whether or not the warming up of the internal combustion engine 2 has been completed. This warming up completed decision is implemented by determining whether or not the temperature T1 of the coolant in the first circulation circuit 3 has exceeded a threshold value. The same temperature as the opening temperature of the thermostat 9 may be set as this threshold value. If warming up has been completed, then the flow of control proceeds to a step S202. But if warming up is not completed, then the flow of control is transferred to a step S204, and the control device 20 closes the on/off valve 18 and thus maintains the state in which the temperature of the coolant in the first circulation circuit 3 is higher than the temperature of the coolant in the second circulation circuit 4.

In the step S202, the control device makes a decision as to whether or not the heater requirement described above is present. If there is a requirement for the heater, then the flow of control proceeds to a step S203, while if there is no heater requirement then the flow of control is transferred to a step S205. In the step S203 the control device makes a decision as to whether or not recovery of exhaust heat by the exhaust heat recovery apparatus 10 has been completed. Completion of recovery of exhaust heat is determined on the basis of whether or not the temperature T2 of the coolant in the second circulation circuit 4 has exceeded a threshold value. This threshold value may, for example, be set to the lower limit value of coolant temperature than can satisfy the heater requirement. If it is determined that recovery of exhaust heat has been completed then the flow of control is transferred to the step S205, while if this is not the case then the flow of control proceeds to a step S204.

In the step S205, the control device 20 opens the on/off valve 18. And then in a step S206 the control device 20 drives either one of the second pump 12 and the first pump. Due to this the CVT can be warmed up, since coolant flows through the CVT warmer 30 via the second communication passage 16.

According to the control of FIG. 11, the CVT is only warmed up if warming up of the internal combustion engine 2 is completed, and moreover if the temperature of the coolant in the second circulation circuit 4 has increased to a level that can satisfy the requirement for the heater. Since, due to this, warming up of the internal combustion engine 2 and the requirement of the heater are prioritized over warming up of the CVT, accordingly it is possible to prevent warming up of the CVT from hampering those processes. It should be understood that, if an automatic speed change mechanism (i.e. an AT) is mounted to the vehicle, then it would also be possible to provide an ATF warmer, instead of a CVT warmer.

Furthermore, in this second embodiment, instead of implementing the control of FIG. 11 or along with implementing the control of FIG. 11, it would also be possible to implement at least one of the various types of control implemented in the first embodiment (i.e. knocking prevention control, control during dead soak, control when the heater is required, warming up promotion control, warming up promotion control during starting, and control when warming up has been completed).

### Embodiment #3

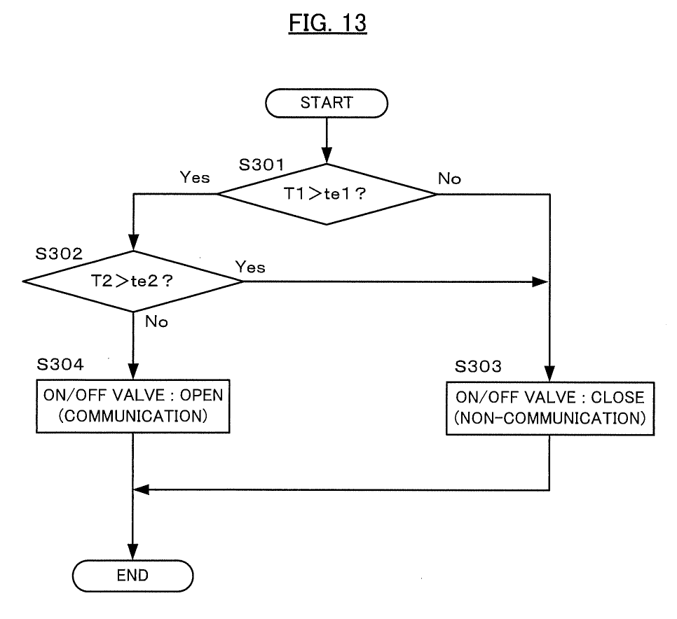

Next, a third embodiment of the present invention will be explained with reference to FIGS. 12 and 13. The same reference symbols will be appended in FIG. 12 to structures that are the same as corresponding structures of the first embodiment, and explanation thereof will be omitted. As shown in FIG. 12, the heat management system 1C of this third embodiment is characterized by the feature that an EGR cooler 35 is provided in the second circulation circuit 4. As is per se known, such an EGR cooler 35 is an element of an EGR device that recirculates exhaust to the internal combustion engine 2, and is a device for cooling the exhaust (i.e. the EGR gas) that is being recirculated.

The coolant temperature required by the EGR cooler 35 changes before and after implementation of EGR. In other words, the required coolant water temperature before implementation of EGR is higher than the required coolant water temperature after implementation of EGR. Due to this, it is necessary to promote warming up of the EGR cooler 35 before implementation of EGR so that it becomes possible to implement EGR at an early stage, and so that it is possible to suppress elevation of the temperature of the coolant in order to ensure the cooling performance for the EGR gas after implementation of EGR. This embodiment is a system that takes the characteristics of this type of EGR cooler 35 into consideration, and in which, by implementing the control of FIG. 13, temperature control adapted to the characteristics of the EGR cooler 35 is made to be possible.

FIG. 13 is a flow chart showing an example of a control routine according to this third embodiment. A program for the control routine of FIG. 13 is stored in the control device 20, and is read out in a timely manner and executed repeatedly at predetermined intervals. First in a step S301 the control device 20 makes a decision as to whether or not the temperature T1 of the coolant in the first circulation circuit 3 is higher than a permitted EGR entry decision temperature te1. While the permitted EGR entry decision temperature te1 is set in an appropriate manner according to the structure of the internal combustion engine 2, the permitted EGR entry decision temperature te1 of this embodiment is set to 70° C. If the coolant temperature T1 is higher than the permitted EGR entry decision temperature te1, then the flow of control proceeds to a step S302. But if the coolant temperature T1 is less than or equal to the permitted EGR entry decision temperature te1, then, since the state in which it is possible to implement EGR has not yet been reached, accordingly the flow of control is transferred to a step S303, and the on/off valve 18 is closed so that the state in which the temperature of the coolant in the first circulation circuit 3 is higher than the temperature of the coolant in the second circulation circuit 4 is maintained. Due to this, warming up of the EGR cooler 35 is promoted.

In step S302, the control device makes a decision as to whether or not the temperature T2 of the coolant in the second circulation circuit 4 is higher than a temperature te2 for determining that warming up of the EGR cooler has been completed. This EGR cooler warming up completed decision temperature te2 is a threshold value for deciding that warming up of the EGR cooler 35 has been completed, and is set to an appropriate value that is lower than the permitted EGR entry decision temperature te1. If the coolant temperature T2 is higher than the EGR cooler warming up completed decision temperature te2, then the flow of control proceeds to a step S303 in which the on/off valve 18 is kept closed, since warming up of the EGR cooler 35 has been completed. Due to this, the cooling performance for the EGR cooler 35 is ensured by the coolant in the second circulation circuit 4, whose temperature is lower than that of the coolant in the first circulation circuit 3. On the other hand, if the coolant temperature T2 is less than or equal to the EGR cooler warming up completed decision temperature te2, then the flow of control is transferred to a step S304 in which the on/off valve 18 is opened, since the warming up of the EGR cooler 35 is not yet completed. Due to this, the warming up of the EGR cooler 35 is promoted by the coolant at high temperature in the first circulation circuit 3 flowing into the second circulation circuit 4.

According to the control of FIG. 13, on the one hand the warming up of the EGR cooler 35 is promoted by coolant at high temperature flowing from the first circulation circuit 3 into the second circulation circuit 4 if the amount of heat is insufficient during the transient warming up of the internal combustion engine 2, and on the other hand the cooling performance of the EGR cooler 35 by the coolant at low temperature in the second circulation circuit 4 is ensured after the warming up of the EGR cooler 35 has been completed by keeping the on/off valve 18 closed. Accordingly, by implementing the control of FIG. 13, it becomes possible to perform temperature control that is adapted to the characteristics of the EGR cooler 35.

It should be understood that, in this third embodiment, instead of implementing the control of FIG. 13 or along with implementing the control of FIG. 13, it would also be possible to implement at least one of the various types of control implemented in the first embodiment (i.e. knocking prevention control, control during dead soak, control when the heater is required, warming up promotion control, warming up promotion control during starting, and control when warming up has been completed).

### Embodiment #4

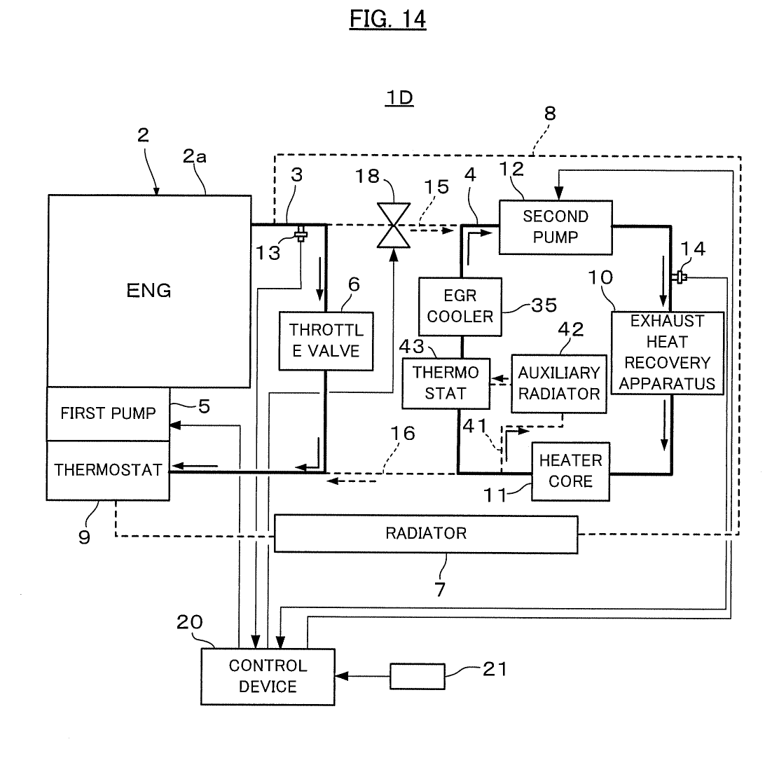

Next, a fourth embodiment of the present invention will be explained with reference to FIG. 14. In this fourth embodiment a structure corresponding to an improvement on the third embodiment is provided for enhancing the cooling performance of the EGR cooler 35. It should be understood that the same reference symbols are appended in FIG. 14 to structures that are common with the third embodiment, and explanation thereof is omitted. As structures that enhance the cooling performance for the EGR cooler 35, the heat management system 1D of this fourth embodiment comprises a branching circuit 41 that branches off between the heater core 11 and the EGR cooler 35 of the second circulation circuit 4 and that joins back again upstream of the EGR cooler 35, an auxiliary radiator 42 that is provided in the branching circuit 41, and a thermostat 43 that is provided at the joining back position of the branching circuit 41. The opening temperature of the thermostat 43 is set to be lower than the opening temperature of the thermostat 9 provided in the first circulation circuit 3.

The control device 20 of this fourth embodiment implements the control of FIG. 13. Due to this, warming up of the EGR cooler 35 is promoted in a similar manner to the case with the third embodiment. Furthermore, when the temperature of the coolant in the second circulation circuit 4 rises after warming up of the EGR cooler 35 and the thermostat 43 opens, the coolant in the second circulation circuit 4 passes through the auxiliary radiator 42 and is cooled. Since, due to this, coolant at a lower temperature as compared to the case with the third embodiment is flowed through the EGR cooler 35, accordingly the cooling performance after warming up of the EGR cooler 35 has been completed is enhanced.

It should be understood that, in this fourth embodiment, instead of implementing the control of FIG. 13 or along with implementing the control of FIG. 13, it would also be possible to implement at least one of the various types of control implemented in the first embodiment (i.e. knocking prevention control, control during dead soak, control when the heater is required, warming up promotion control, warming up promotion control during starting, and control when warming up has been completed).

The present invention is not limited to the embodiments described above; various embodiments could be implemented within the range of the gist of the present invention. While, in the embodiments described above the communicating section was structured as being two communication passages, and an on/off valve was provided as a control valve in one or the other of those passages, the number of communicating sections and the place where the control valve is installed are not particularly limited, provided that it is possible to change over between mutual communication of the first circulation circuit and the second circulation circuit, and prevention of that communication.

While, in the embodiments described above, the on/off valve that performed opening and closing of the first communication passage 15 was provided as the control valve, instead of this type of on/off valve, it would also be possible to provide a valve whose opening amount can be continuously varied as the control valve. Since, if this type of valve is provided, it is possible to adjust the flow rate of the coolant that flows between the first circulation circuit and the second circulation circuit in a continuous manner, accordingly it becomes possible to adjust the temperature of the coolant more delicately when implementing control of the type described above. Furthermore, it becomes possible to adjust the temperature of the coolant more accurately, by controlling the opening amount of the above valve and the drive duty of the first pump or the second pump in a collaborative manner.

What is claimed is:

1. A vehicle heat management system applied to a vehicle to which an internal combustion engine is mounted, comprising:
a first circulation circuit that cools an engine body of the internal combustion engine, and in which is provided a first pump that pressure feeds coolant;
a second circulation circuit in which are provided an exhaust heat recovery apparatus that recovers exhaust heat of the internal combustion engine, a heater core that is used for air conditioning of the vehicle, and a second pump that pressure feeds coolant;
a communicating section that communicates together the first circulation circuit and the second circulation circuit so as to be able to mix together the coolant in the first circulation circuit and the coolant in the second circulation circuit;
a control valve provided in the communicating section, that can be changed over between communicating together the first circulation circuit and the second circulation circuit, and preventing such communication; and
a coolant temperature control device configured to control the control valve, so as to implement a state in which the temperature of the coolant flowing in the first circulation circuit is higher than the temperature of the coolant flowing in the second circulation circuit.

2. A vehicle heat management system according to claim 1, wherein an EGR cooler is further provided in the second circulation circuit.

3. A vehicle heat management system according to claim 1, wherein the coolant temperature control means controls the control valve so as, if the load demanded from the internal combustion engine arrives at a load region in which knocking may easily occur, or if there is a possibility that the load may arrive at the load region, to communicate together the first circulation circuit and the second circulation circuit.

4. A vehicle heat management system according to claim 1, wherein, during dead soak, the coolant temperature control means controls the control valve so as to communicate together the first circulation circuit and the second circulation circuit.
